(19) United States
(12) Patent Application Publication
(10) Pub. No.: US 2013/0080220 A1
(43) Pub. Date: Mar. 28, 2013

(54) Electronic System for Marketing Beverages

(71) Applicant: Peter Allnutt, Margaret River (AU)

(72) Inventor: Peter Allnutt, Margaret River (AU)

(73) Assignee: Winescape Pty Ltd, Margaret River (AU)

(21) Appl. No.: 13/552,908

(22) Filed: Jul. 19, 2012

(30) Foreign Application Priority Data
Sep. 23, 2011 (AU) 2011903919
Apr. 2, 2012 (AU) 2012201917

(51) Int. Cl. G06Q 30/02; G06Q 30/06

(52) U.S. Cl. 705/14.4

(57) ABSTRACT

An electronic system for marketing beverages uses an information storage device for electronically storing product information about beverages for sale by beverage suppliers; a module for a prospective buyer to view beverage product information over a data network; and a module for registering a prospective buyer request of a beverage supplier for a sample of a beverage recorded in the information storage device and sending the sample request to the beverage supplier over a data network. The electronic system has a bargaining module enabling the prospective buyer and a beverage supplier to bargain, through communications sent through the data network, a purchase price for a quantity of the beverage following buyer sampling; and a contracting module enabling the beverage supplier to contract with the buyer for purchase of a quantity of sampled beverage at an agreed purchase price.

The present invention relates to an electronic system for marketing beverages.

Marketing and distribution of consumer products including food and beverages is highly competitive. Margins may be small and it is important to reduce marketing costs as much as possible. Such philosophy applies to a wide range of consumer goods including food and beverages. Beverages, such as wine, may be made in boutique or custom quantities, sometimes by small volume beverage producers. Such small volume producers may often not have the means to market and distribute their products in a cost effective and profitable manner.

In the case of wine, larger companies growing fruit and making wine from that fruit are involved in a primary industry where production is dictated by the vagaries of the weather. This creates an environment where the amount of wine to feed theft companies brands is either oversupplied or undersupplied. Where a company has an excess of wine, a wine company may increase the market share of the brands they own (to sell the excess) or they will look to sell the wine as a commodity. Increasing market share for brands in competitive consumer markets is difficult and as such wineries in a position of oversupply often choose to sell wine as a commodity. In these instances the wine does not lean on traditional marketing techniques to build a following but purely on its generic qualities. Wine is described and sold using four variables 1) varieties of grape from which the wine is made, 2) the year the grapes were grown to make the wine, 3) the region from which the grapes were grown and 4) the taste of the wine. A prospective buyer of bulk wine will elect to buy wine based on these four variables.

Wine companies in an undersupply position are buyers of commodity wine and will look to buy Bulk or Cleanskin wine from companies that are in an oversupply position so that they can meet their legal and market requirements. Consistency of supply is vital to meet market requirements.

In the wine industry, there is much focus on minimizing costs of marketing and distribution. Profits in the wine industry are variable. There are often periods where there is too much wine available for sale and this leads to a reduction in prices. When prices are reduced, profit margins come under pressure and costs must be reduced in an effort to sustain profitability.

Some wine products have a low margin of profit due to their nature. Such wines may be described as cleanskin products, wines which are sold to customers—typically in bottle units—under a generic label, which does not identify the winemaker, or very minimal labeling (the minimum legally required information being provided) in some cases. Wine products may also be supplied as bulk wine, wine available in very large quantities from tanks or similar storage units. Wine wholesalers source such wines to promote volume sales and as low a unit marketing cost as possible.

The origin of cleanskin wines may vary. In some cases, the wine will have been produced to be sold as cleanskin wine. In other cases, the cleanskin wine may be a re-labeled product or a product that has previously been labeled as another brand where a winemaker wishes to liquidate product. In such cases, selling as cleanskin should not affect the value of the winemaker's brands. This variation in origin means that there will be variation in quality and sampling is essential to assessing the true quality of the wine. Whereas more prominent wines may be rated in prestigious wine guides, cleanskin type wines are most commonly not rated in such a sophisticated manner. Rather the wholesaler will reasonably procure the wine following sampling of a smaller quantity of the wine. This differs from the sales process for retail consumers who must generally purchase wine, certainly through on-line or electronic systems, without benefit of a sampling step. Retail consumers are persuaded to buy by recommendations from friends, retailers and wine writers. If they buy a bottle or case of wine that they don't particularly like they are only out of pocket for the comparatively small price of the sale. This is not the case where a wholesale transaction occurs and the quantities and risks of loss are much greater. In these circumstances the wine must be tasted to ascertain if it fits the buyer's requirements.

Producers of cleanskin wines could seek to distribute and market on their own account. However, there are costs to this. Benefits may be achieved by using wine marketing and distribution systems provided for use by a number of wine producers. The operator of the marketing and distribution system may arrange for samples to be delivered to potential buyers. In such cases, a central distribution centre—where wines are stored or warehoused—is likely to be an important, though expensive, element. Wine producers send details of wines for sale. Data about the wines is loaded into the system and potential purchasers obtain samples of the wine through the operator of the marketing and distribution system as a first step in procuring wine for wholesale purposes. The involvement of the operator in obtaining samples from producers or suppliers and delivering samples to potential purchasers takes time. It would be desirable to accelerate the sampling to purchase process and make it more flexible to different types of sales transaction.

It is the object of the present invention to provide an electronic system for marketing beverages which accelerates and reduces costs of marketing and distribution and which is more flexible to different types of sales transaction.

With this object in view, the present invention provides an electronic system for marketing beverages over a data network comprising:

an information storage device for electronically storing product information about beverages available for supply by beverage suppliers;

a module for a prospective buyer to access said beverage product information stored in said information storage device over a data network; and

a module for registering a prospective buyer request of a beverage supplier for a sample of a beverage recorded in the information storage device and sending the sample request to the beverage supplier over the data network;

wherein said electronic system comprises a bargaining module enabling the prospective buyer and a beverage supplier to bargain, through communications sent over the data network, a purchase price for a quantity of the beverage following buyer sampling; and a contracting module enabling the beverage supplier to contract with the buyer for purchase of a quantity of sampled beverage at an agreed purchase price, the bargaining and contracting modules being accessible over the data network.

The present invention also provides a method for marketing beverages over a data network communicating beverage buyers and beverage suppliers through an electronic system which comprises an information storage device for electronically storing product information about beverages available for supply to buyers by beverage suppliers and further comprising:

providing a buyer with access to said beverage product information over the data network;

registering and sending a buyer request for a sample of an available beverage recorded in the information storage device to a supplier over the data network;

bargaining, through communications sent over the data network, a purchase price for a quantity of the beverage following buyer sampling; and

contracting between buyer and supplier for purchase of a quantity of the beverage at an agreed purchase price.

The beverage marketed through the electronic system may be selected from a range of alcoholic and non-alcoholic beverages with the system most advantageously applied to marketing of commercial quantities of the beverage, rather than retail quantities. In such case, the prospective buyer is a wholesale purchaser of the beverage. Retail consumers need not be excluded, on basis of likely insufficient purchase quantity, from access to the system but the agreed purchase price for a retail consumer would typically be higher than that agreed with a wholesale buyer as costs of supplying beverage to a retail consumer would typically be higher per unit quantity of beverage purchased. The electronic system is particularly useful for marketing wine to be supplied, as a commodity, in commercial or bulk quantities, for example in the form of so-called ‘cleanskin’ or bulk wine.

Beverage suppliers are required to register to use the electronic system. The system provider may require information about issues such as supplier identifying information and, on the product side, beverage type, quality, provenance and availability before allowing supplier registration. A provider of the system may also verify details about the supplier, its location and available beverage products before finalizing supplier registration.

Prospective buyers are also conveniently registered, at least before any contract to purchase beverage is completed. Registration may involve provision of identifying information about the prospective buyer, particularly the buyer's delivery address. This information is important as once a Buyer and Supplier reach agreement and a contract note is raised, it is the information that is entered at registration that forms part of the contract. The contract note draws the Sellers and Buyers details from their registration.

The beverage marketing system includes a module to enable buyer and supplier registration. It is to be understood that buyer and supplier may be located in the same or different jurisdictions. Similarly, the provider of the system may be located in the same or different jurisdiction to buyer, supplier or both.

Following registration, a supplier is permitted to upload information about its beverage products into the information storage device of the electronic system. The information may be provided by text or other file. Conveniently, the information may be provided by loading a spreadsheet file into the information storage device. However, the system could include a database, of SQL or other type to enable such information to be uploaded. Information required by the system may typically include grape variety (or blend of varieties), region from which wine originates, year wine was made, quantity of wine available for purchase and so on. An indicative purchase price may also be included in the list.

The electronic system may issue requests to a beverage supplier to confirm database information about beverages it offers for sale at set time intervals, for example 30 day intervals. Such requests are aimed at ensuring database information is accurate or current, for example as to the nature and quantity of beverages offered for sale. If requests are not responded to by beverage supplier within a set period of time, its product information may be deleted from the beverage information database or marked, by the system, as ‘old’ data.

When the beverage product information is uploaded into the information storage device, prospective buyers may request samples of beverage products listed in the information storage device. When a sample request is received and accepted by a supplier, an obligation to provide the sample is created. The electronic system may generate a label for use by the supplier following its acceptance of a sample request.

The electronic system provides the supplier with a discretion to refuse a sample request. For example, the beverage for which a sample is desired may be unavailable due to cost or legal reasons. Legal reasons may include prohibition on supplying a buyer with a sample in the buyer's geographic location. The system itself may prevent sample requests being sent from a particular geographic location if contrary to law.

The electronic system envisages that beverage samples will be sent directly from the beverage supplier to prospective buyer requesting such samples. That is, there is no need for any central storage facility under the control of the system provider. Similarly, once sold, beverages will be supplied directly from beverage supplier to beverage consumer. The object is to reduce the distribution hierarchy to the maximum possible extent. The system provider advantageously avoids need to hold quantities of beverages offered for sale at some warehousing location and consequential warehousing costs. The speed of supply of beverage to consumer is also increased where the beverage supplier is not required to deliver beverage first to system provider controlled warehouse location followed by collection, or distribution, of beverage to the buyer.

If the buyer finds a wine acceptable for purchase based on the sample, the bargaining module enables the prospective buyer and a beverage supplier to bargain a purchase price for a quantity of the beverage by system supervised interaction over the data network. The bargaining module controls the bargaining process, including format of offer/counter-offer documents and the number of offers and counter-offers that can be made by prospective buyer and supplier. The number of iterations of offer and counter-offer may be capped by the electronic system. In addition, the system allows the buyer or seller to flag an offer/counter-offer as a final non negotiable offer terminating the bargaining process if acceptance does not result.

On successful conclusion of a bargaining process, the system also includes a contracting module enabling the beverage supplier to contract with the buyer for purchase of a quantity of sampled beverage at an agreed purchase price. The contracting module allows the buyer and supplier to document her agreement through the system which generates a contract note documenting the transaction for transmission over the data network to buyer and supplier. The contract note is raised upon acceptance of buyer or seller of an offer or counteroffer.

The electronic system may impose conditions on the supply of beverage. For example, the supply may be subject to further information about the beverage being provided to the buyer. In the case of wine, this may include a condition that exact composition of the wine will be provided to the buyer, for example by a compliance statement (called a Label Integrity Program statement in Australia) within a certain time. Failure to deliver the statement in required time allows the contract to be rescinded at the buyer's option.

The electronic system may collect payment through conventional methods for Internet based transactions. Following payment, the provider of the electronic system may collect, as remuneration, a proportion of beverage purchase price as agreed between the supplier and consumer. To that end, the system records contract price as agreed between supplier and consumer and assesses remuneration as a proportion, for example a percentage, of the contract price. The proportion may vary with the quantity of beverage sold. The proportion would typically reduce as quantity of beverage purchased increases. The party providing the electronic system may be independent of beverage suppliers and buyers using the system.

Recording and analyzing information from contracts agreed between suppliers and buyers also allows the beverage marketing system to be used as a valuation tool. For example, the system may track volumes and prices of wines by characteristics such as variety, region of origin, year wine made and so on. The system can then provide information about sales volumes, calculating volumes and average prices and displaying the information on a graph or a bar chart. The system may therefore be usefully used as a wine valuation tool, allowing suppliers and buyers to review current prices and design bargaining strategy around those prices. The provider of system may also use the valuation tool to forecast its future earnings. For example, over time, the system records income from wine sales and this information acts as a predictor of future incomes.

The electronic system may include a tender module which allows a beverage buyer to create and record a tender for supply of at least one beverage product to it. The tender process enables a registered buyer to enter information to the system about the kind, quantity and/or other characteristics of beverage product that they are looking for. Typically, a wine buyer would be looking to describe the wine they are looking for in terms that cover 1) varieties of grape from which the wine they wish to buy is made, 2) the year the grapes were grown to make the wine, 3) the region from which the grapes were grown 4) the taste of the wine and 5) the price that they are willing to pay for a quantity of the wine.

The system accelerates the sample to purchase process and reduces beverage marketing and distribution costs through efficient supervision of transactions in the sample to purchase process. At the same time, the system provides buyers and suppliers with an auditable trail from upload of content, labels provided for samples, offer/counter-offer process, contracting and through to supply of the beverage product. Use of the system, by buyers and suppliers, minimizes or avoids altogether the human errors that can arise from marketing and distribution based on media such as phone and e-mail without use of a consistent system.

A preferred embodiment of the electronic system for marketing beverages is now described by reference to the following figures in which:

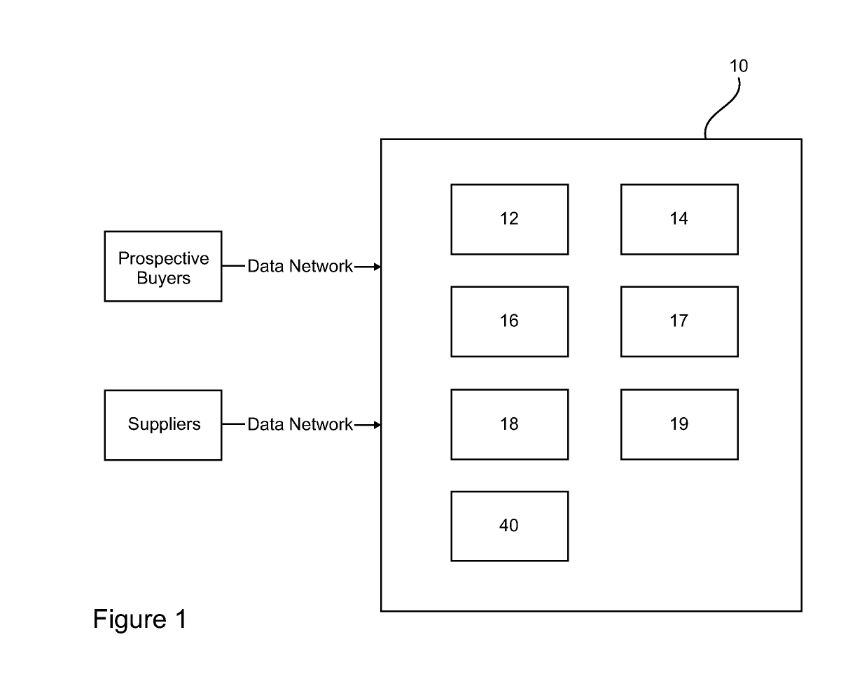

FIG. 1 shows an electronic system for marketing beverages in accordance with the preferred embodiment.

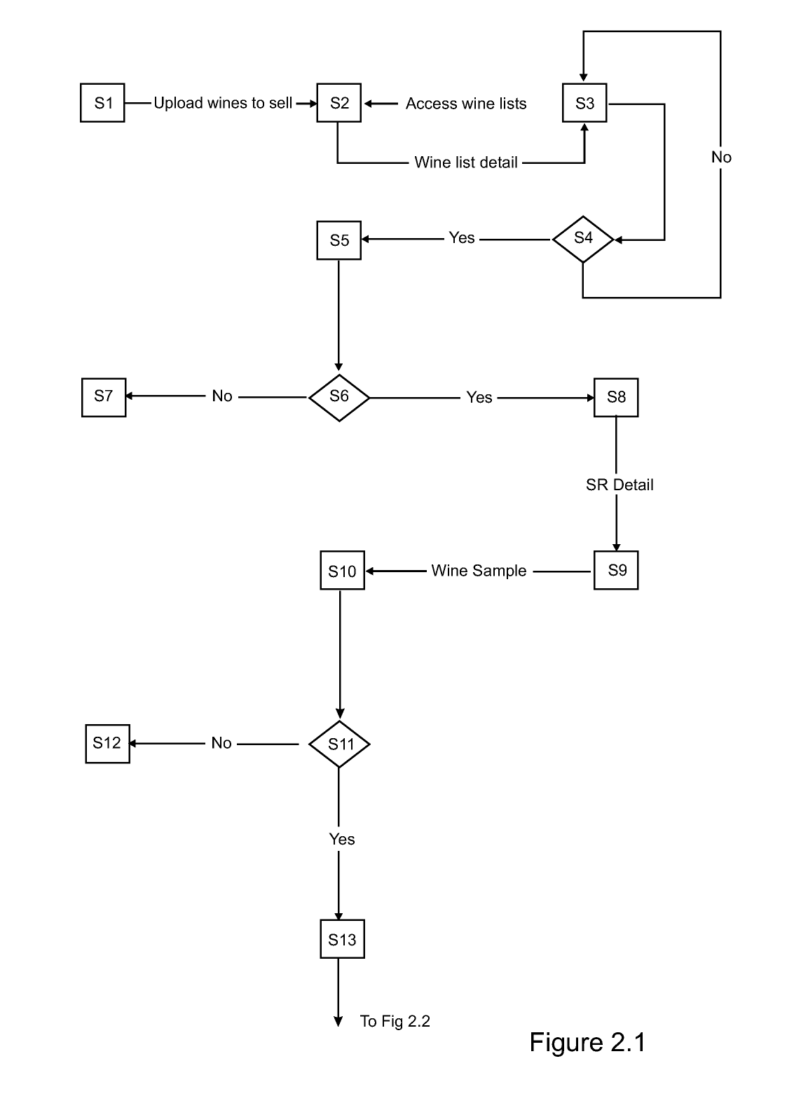

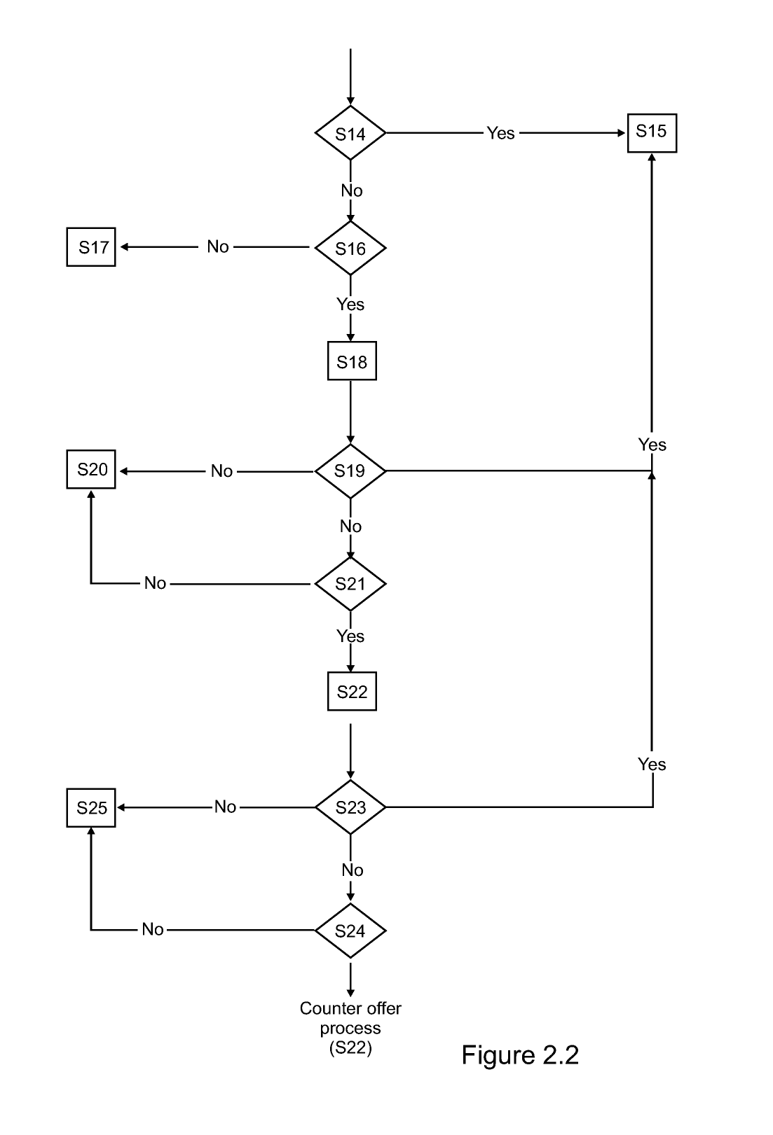

FIGS. 2.1 to 2.2 show a block diagram illustrating operation of the electronic system of FIG. 1.

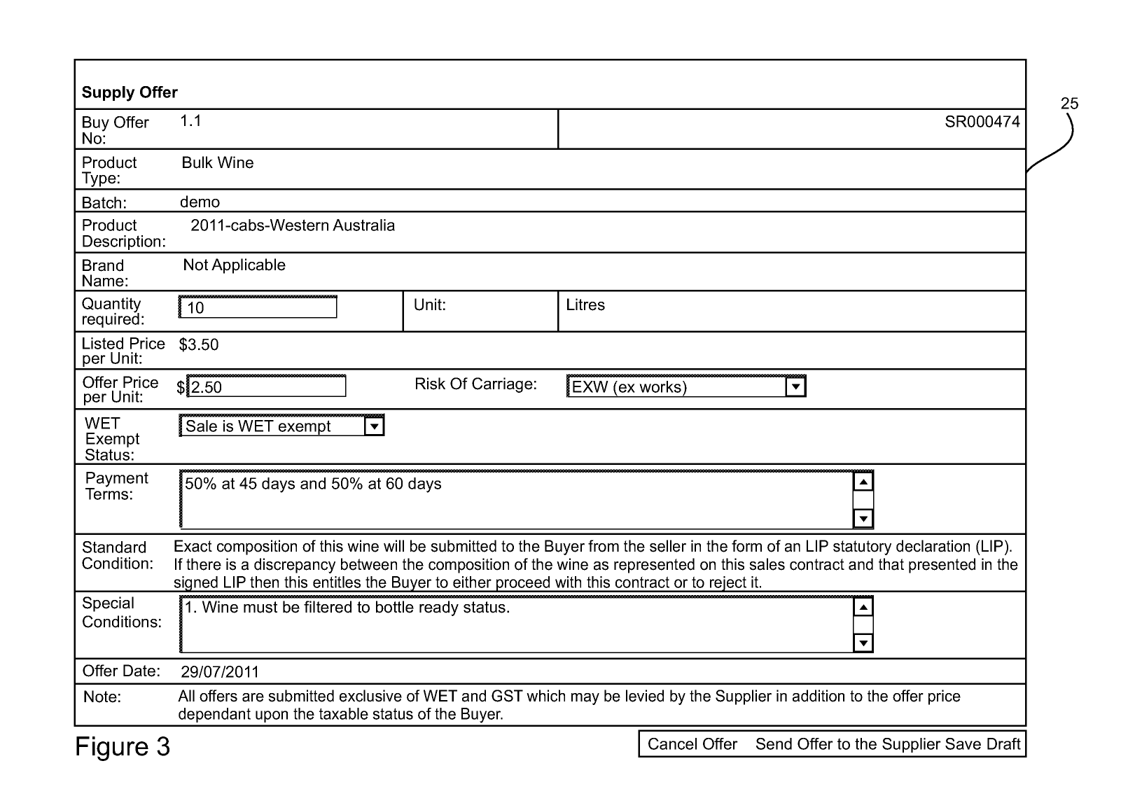

FIG. 3 shows a form for making an offer to purchase a quantity of wine using the electronic system as illustrated by FIGS. 1 and 2.

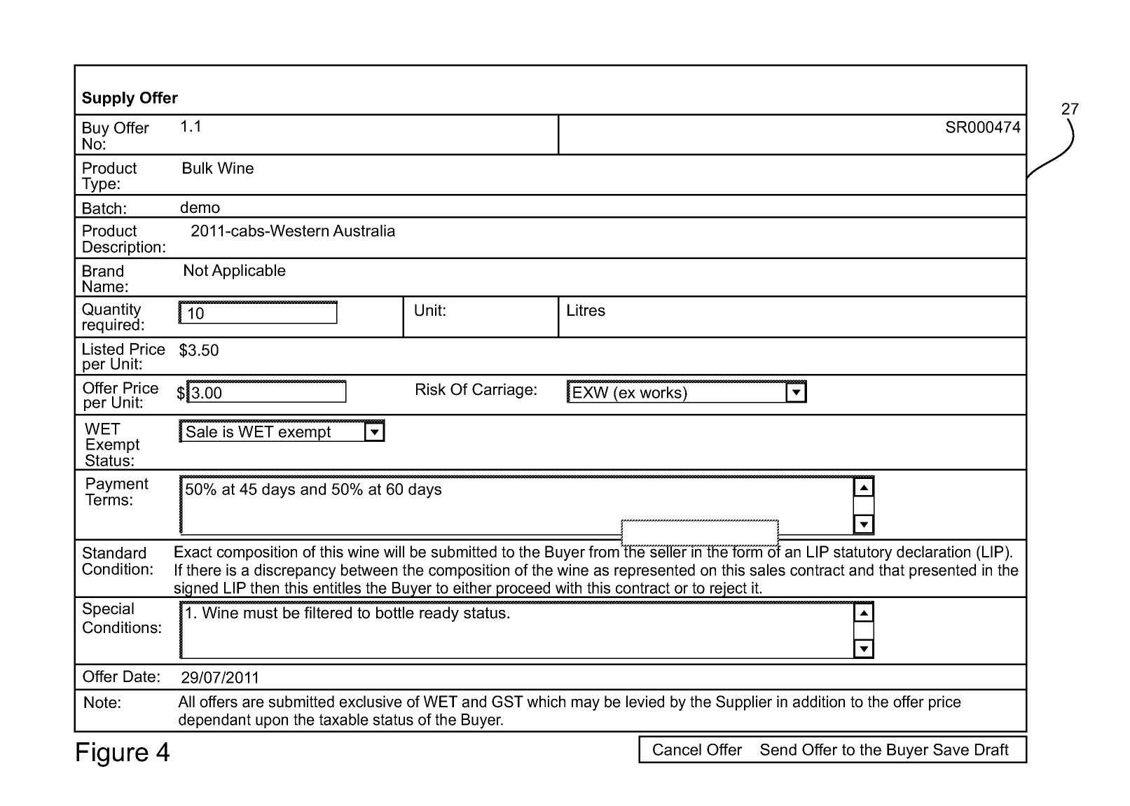

FIG. 4 shows a form for making a counter-offer in response to the offer form of FIG. 3.

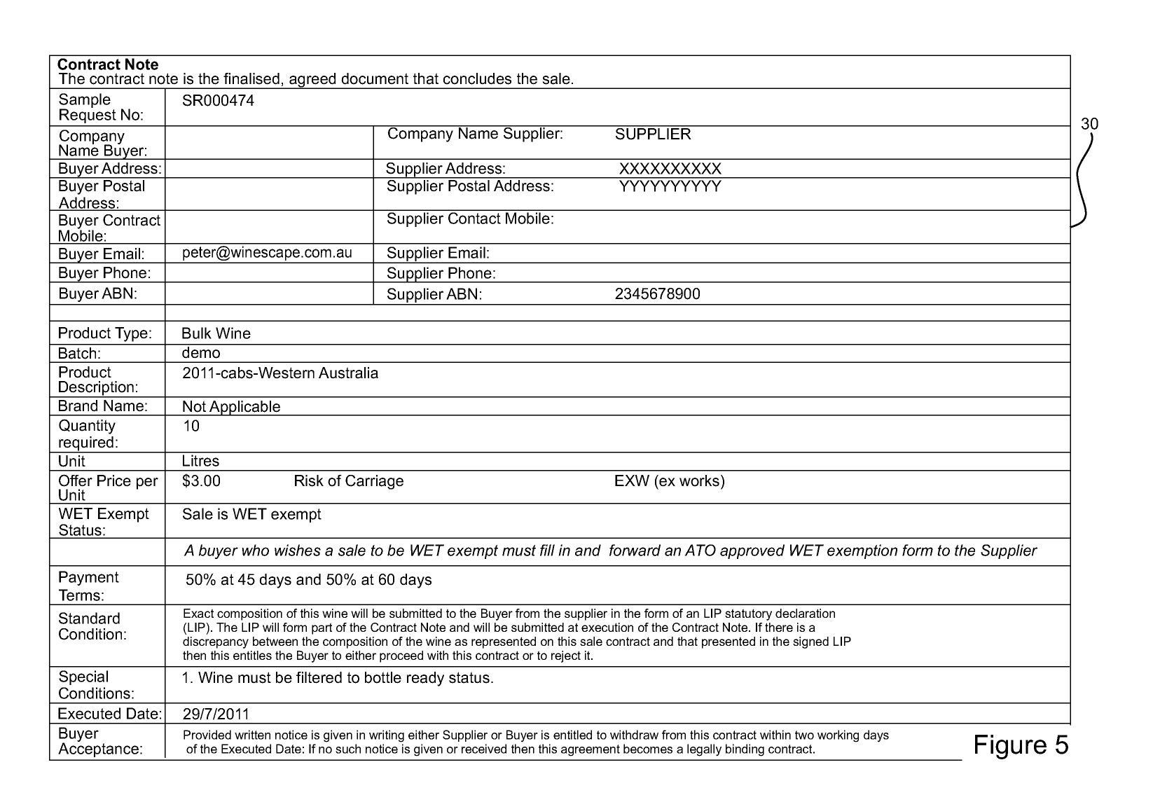

FIG. 5 shows a contract note documenting purchase of quantity of wine for an agreed purchase price following acceptance of the offer shown in FIG. 3.

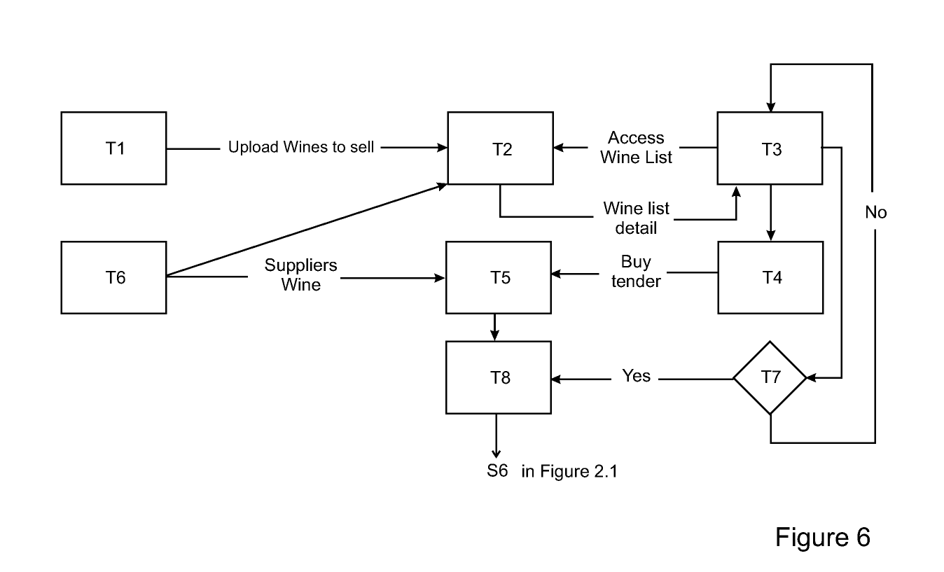

FIG. 6 shows a block diagram showing operation of the tender module of the system shown in FIG. 1.

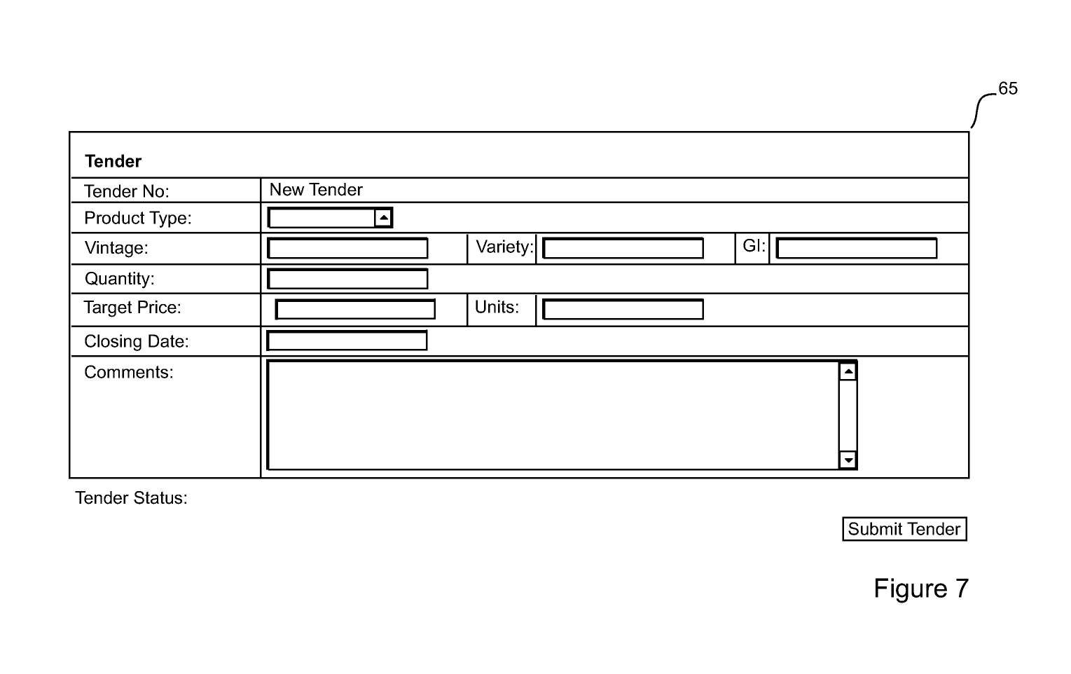

FIG. 7 shows a blank form for setting up a buyer tender for wine using the electronic system of FIG. 1.

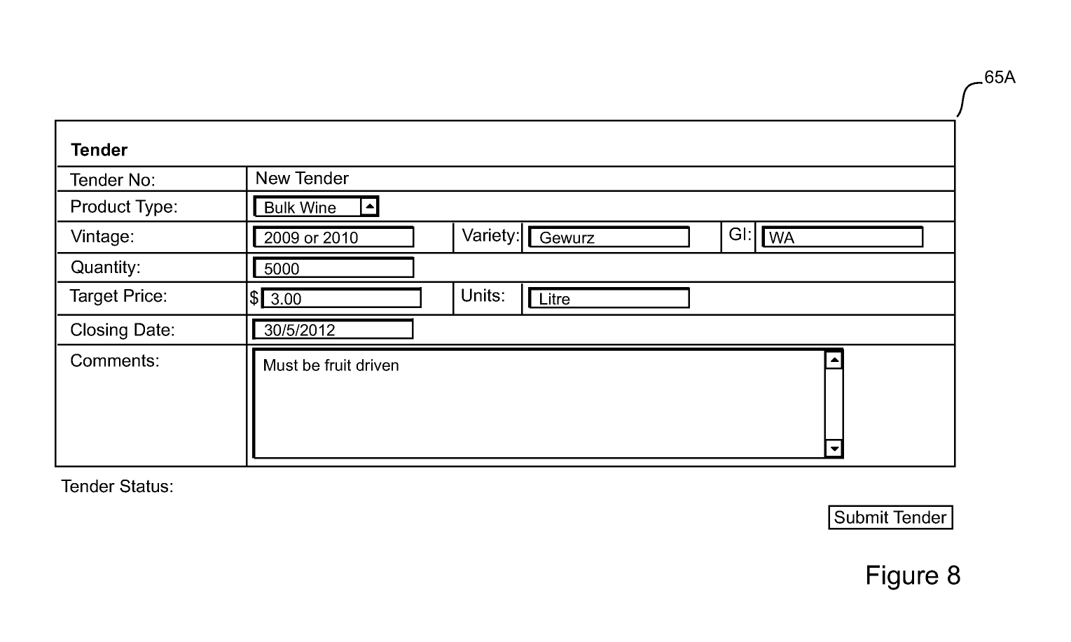

FIG. 8 shows the form of FIG. 7 populated with terms for the wine the buyer is seeking to obtain through tender.

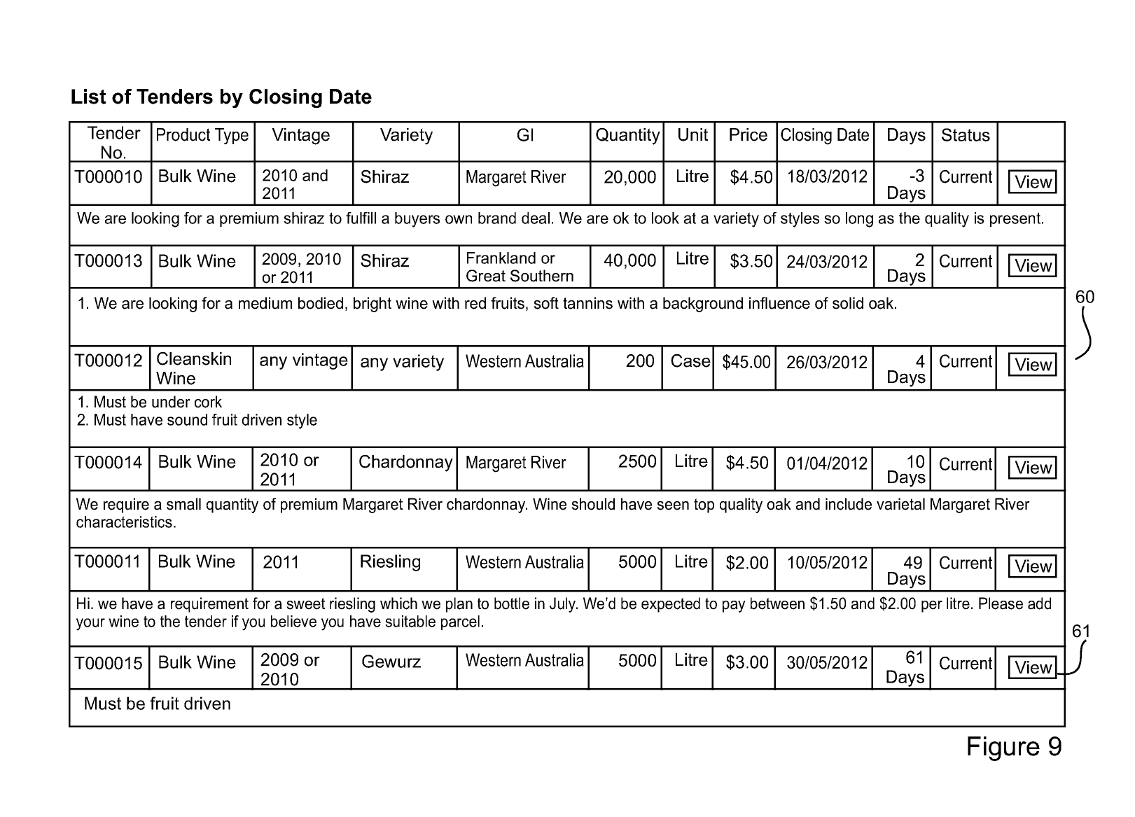

FIG. 9 shows a list of tenders viewable through the electronic system of FIG. 1.

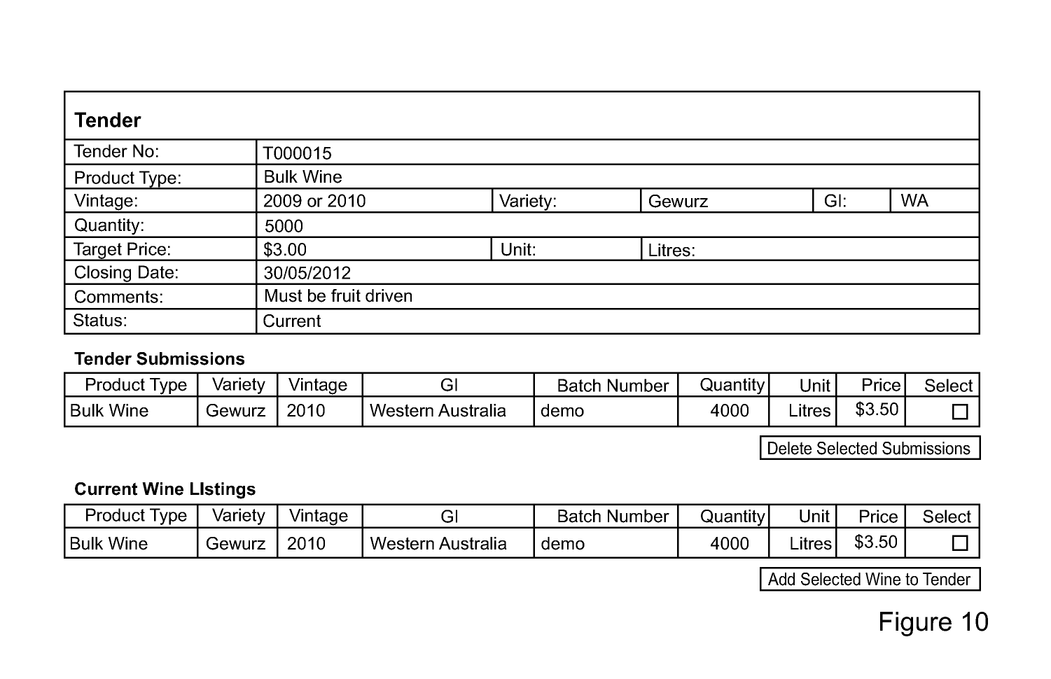

FIG. 10 shows a supplier response to the buyer tender set up through the electronic system using the forms shown in FIGS. 7 and 8 and viewable as shown in FIG. 9.

Referring to FIG. 1, there is shown an electronic system 10 for marketing beverages, here cleanskin and bulk wines in wholesale quantities. The system 10 is computer implemented with a server 12 including—or interfaced with—an information storage device 14 for electronically storing information about wines available for supply from suppliers to prospective buyers and software to implement the system 10.

Buyers and suppliers communicate with the system 10 over a data network, for example over a global computer network such as the internet with the system being primarily web-based and not based, for example, on a series of essentially uncontrolled or random e-mail or text (SMS) exchanges using non-system software such as conventional e-mail packages. Transmission of certain communications concerning the system by e-mail or text (SMS) is not excluded, and may be convenient for certain steps, but successful use of system 10 requires both prospective buyers and suppliers to interact with system 10 through communications sent through web or like access whether by using server 12 generated forms, selection of radio buttons corresponding with particular system options or selection of similar inputs. System 10 includes the necessary hardware and software to facilitate specifically defined communications or transactions in the sample to purchase process as described below. This allows the electronic system 10 to efficiently control the purchasing process and ensure consistency across plural transactions.

Whilst the electronic system 10 may most conveniently be accessed by laptop or desktop computer used, through interfaces (typically graphic interfaces) by beverage buyers and suppliers, it could also be accessed by a mobile enabled device such as a PDA.

The wine marketing system 10 is conveniently accessed over the internet through a website. The website is accessed through the data network by prospective buyers and suppliers, following registration, through interfaces incorporating interface elements that facilitate supplier and buyer interaction with system 10. The website interface may provide a number of interface elements for buyers and suppliers to interface with system 10 whether by images, interactive elements, images, shopping cart options and so on. System 10 is conveniently forms based with buyers and suppliers interacting with each other, through forms generated by server 12, populated by the buyer or supplier (as appropriate) and then sent to the other party during use of the system 10. System 10 requires standardization of the format of the forms and this itself facilitates the marketing process by reducing instances of error due to misunderstanding of communications, a real possibility if using communication methods such as e-mail, SMS message or telephone.

The website is secured, requiring both buyers and suppliers to log-in to the system 10 using a username and password. Username and password are provided following a registration process started by selection of a “Register” option. The registration process may be initiated, and even completed, on-line. However, the provider of the wine marketing system 10 may require further inquiries to be made of a supplier before finalizing the registration process. Therefore, supplier registration—in particular—may not be finalized in a single session of access to the website.

For supplier registration, the provider of the wine marketing system 10 requires information identifying the supplier and, on the product side, information about beverage type, quality, provenance and availability. This information is registered in the “supplier” database of information storage device 14. For buyer registration, only buyer identifying information is required for registration in the “buyer” database of information storage device 14. A user of the system could register as both a buyer and supplier. The provider of system 10 may conduct such authentication as necessary to achieve desired system security and integrity.

Following supplier registration, the supplier can load information about its available wines into information storage device 14 by selecting a “Sell” option on the website and loading its winelist into the information storage device 14.

The wine marketing system 10 includes a module 16 for a prospective buyer to view, on a display of the prospective buyer's own computer (or suitable electronic device), information about wines available for supply to them over the data network. So, when a prospective buyer accesses the system 10, they may access this module 16, for example by selecting a “Buy” option on the wine marketing system web page. System 10 may display a radio button to allow the “buy” selection input to be made. Information about wines may be provided in the form of winelists sent as web page viewable in the web browser of the buyer's computer. However, a prospective buyer may also access further information by selecting a wine of interest, this selection directing the buyer to further information which could be contained in the information storage device 14. Alternatively, highlighting the wine of interest may direct the prospective buyer to a source of information, for example the supplier's website, external to the information storage device 14 of server 12.

Prospective buyers, in accordance with typical practice, would require samples of wines to be supplied for tasting before making purchases. So, the wine marketing system 10 also includes a module 17 for registering a prospective buyer request of a beverage supplier for a sample of a beverage recorded in the database and sending the sample request, through the data network, to the beverage supplier. Module 17 may be accessed by the prospective buyer by selecting a wine of interest. The prospective buyer is then presented with an option to make a sample request. Again, system 10 may provide a web page with a radio button or similar input device for this purpose. If the sample request option is selected, the sample request is registered in module 17 and sent to the supplier through the data network. The buyer is advised by system 10 if the sample request is accepted by the supplier. The supplier is provided with a system generated label for use in marking the sample.

Following sampling, the prospective buyer may decide to purchase a quantity of the sampled wine. Wine marketing system 10 therefore comprises a bargaining module 18 enabling the prospective buyer and cleanskin or bulk wine supplier to interact, over the data network and under system 10 supervision, to bargain a purchase price for supply of a quantity of the sampled wine. Bargaining module 18 allows the buyer to make an offer, subject to buyer conditions if desired, which the supplier may immediately accept. However, module 18 also allows the supplier to make a counter-offer. The format of offer and counter-offer, which are forms accessible through the data network, and downloaded as web pages on supplier and/or buyer request, is controlled through system 10. System 10 requires standardization of the forms though allowing some flexibility for buyers and suppliers to populate the forms, on their own computers, to accord with the specific transactions they wish to make.

The offer/counter-offer process may continue until a price is agreed or the process terminates without agreement between buyer and supplier. System 10 may terminate the bargaining process after a certain number of offers or counter-offers.

Once buyer and supplier reach agreement on purchase price and any other conditions, wine marketing system 10 also includes a contracting module 19 enabling the beverage supplier to contract with the buyer for purchase of a quantity of sampled beverage at an agreed purchase price. The wine marketing system 10 may generate a contract note, evidencing the contract between buyer and supplier. The contract note may include standard conditions such as set by the provider of system 10. Such standard conditions cannot be amended by buyer and supplier. However, the contract note may be customized to some extent, for example to allow for the particular circumstances of the buyer and supplier. The buyer and supplier may agree particular conditions, for example, on wine quality, insurance (risk of carriage) and completion of the contract being subject to properly completed regulatory requirements, such as the requirement—in Australia—for a Label Integrity Program (LIP) statement. The contract may be completed by the buyer and supplier on-line.

Referring to FIG. 2, further description is made of the operation of wine marketing system 10.

Following successful conclusion of supplier registration, at step S1, a supplier uploads information about cleanskin and bulk wines it has for supply into the information storage device 14 of system 10. The supplier uses an Excel® spreadsheet file listing the wines for this purpose. System 10 could enable use of other spreadsheet packages for example Lotus Symphony®. The spreadsheet file, or winelist, includes the following information: grape variety (or blend of varieties), region from which wine originates, year wine was made, quantity of wine available for purchase and so on. An indicative purchase price is also included in the list.

The supplier loads the winelist to the information storage device 14 of system 10 by any convenient means. The website may allow the supplier to locate the winelist file in its browser and then load it into the information storage device 14 using a conventional process for capturing files to a web enabled communication system.

System 10 may require the supplier to verify or update the winelist information at regular intervals, say 30 day intervals since accuracy of winelists is important to the integrity and usefulness to buyers. If this step is not completed within a pre-set time, the winelist may be electronically deleted from the information storage device 14 or marked by system 10 as ‘old’ data. Such data may be archived for later analysis by the system provider, for example as described below.

Following winelist upload completion, at step S2, prospective buyers may, through selecting a “buy” option on the website, access the wine list through module 16 at step S3. The prospective buyer makes a decision about whether samples are required of the viewed wines at step S4. Supplier identity may not be disclosed to the buyer at this stage. The step S4 process may continue till all wines on the list have been reviewed. For wines of no interest, review continues without a sample being required. The prospective buyer could review a number of winelists uploaded into information storage device 14 before selecting a wine or group of wines, if any wine for sampling.

A buyer may, alternatively to reviewing available wines, elect to set up a tender using tender module 40 of electronic system 10. Operation of system 10 to enable tenders is described below.

When the prospective buyer decides to sample a listed wine, a sample request is made by registering this sample request in module 18. The prospective buyer may simply click a “make sample request” option on the website. A winelist could be formatted such that a prospective buyer can only purchase the entire quantity of a listed wine and not a part quantity. Such sample request process contrasts from prior practice. Previously wine brokers would receive sample requests by phone or email. The brokers would then canvas the market for stock. The market would then send samples back to the broker who would then on-send to the Buyer. System 10 therefore allows substantially faster sample sourcing than traditional broker models.

At step S5, system 10 sends the sample request through a data network (here the internet) to the supplier. At step S6, the supplier decides whether to accept the sample request. In most cases, the sample request would be accepted and a “sample request accepted” notice sent to the prospective buyer at step S8.

However, the supplier has a discretion at step S7 to reject the sample request, for example if the request is made of an unavailable wine or the request is made from a location to which the supplier is prohibited, by cost or law or competition from sending samples. System 10 may be configured to automatically reject such a sample request. If the sample request is rejected, the supplier provides this information to system 10. System 10 then sends a sample request reject notice to the prospective buyer through the data network. System 10 archives details of any rejected sample request. System 10 may recover these details if required.

In a variant of step S8, the supplier could be provided with an option to offer a substitute wine for sampling. For example, the wine of interest to the prospective buyer may not be available but a very similar wine may be available to offer as a substitute.

The supplier holds a quantity of the wine to be sampled under its own control. The provider of wine marketing system 10 conveniently does not have a warehousing facility, saving warehousing costs. This also saves double handling which would occur in the traditional process of selling bulk and cleanskin wine where wine is sent from supplier to the broker and then out to the buyer. The system 10 provider therefore does not send the sample, the supplier is responsible for the sample dispatch step. The supplier directly dispatches the sample to the prospective buyer's address (as supplied by the buyer during the buyer registration process) and provides this dispatch information to system 10 at step S9. The system 10 provides the supplier with a printed label to attach to the sample with the same information that was uploaded to the system 10, in spreadsheet form, by the supplier. The system 10 may send reminders to the supplier to send a sample, if the dispatch information is not registered by system 10 within a certain timeframe.

The prospective buyer evaluates the sample in conventional manner at step S10 and makes a decision about whether to make an offer to purchase the sampled wine at step S11. If the buyer does not wish to offer, the system 10 is updated accordingly and the supplier is informed by a sample rejection notice at step S12.

If the prospective buyer wishes to make an offer to purchase, a form to make the offer is generated by system 10 and may be completed by the prospective buyer online at step S13. An example of the offer form is provided as FIG. 3. The offer form 25 requires the prospective buyer to input the following information:
Quantity of wine to be purchased (in number of units, whether bottles, liters or some other volume measure being a more convenient unit than bottles for transactions involving bulk wine)).
Offer price per unit of wine to be purchased. Here, the offer price of $2.50 a bottle is at the lower end of a typical wholesale price range for an Australian cleanskin wine.
Risk of carriage information (i.e which party bears insurance risk and the method of insurance).
Payment terms (though these may be predetermined by the system provider).
Any special conditions the prospective buyer wishes to apply (here that the wine must be filtered to bottle ready status). The system 10 allows customization of the special conditions. That is, any condition the buyer wishes to include can be inserted in the form.
Whether transaction is tax (Wine Equalization Tax in Australia) exempt or not.

An offer date is automatically set by system 10. Other conditions on the offer form may be standardized to all transactions using system 10.

The offer form 25 does not need to be completed during one buyer session of using the website. A draft offer form can be saved by the buyer, if required, using the “save” option and completed at a later time.

When the offer is completed and the buyer selects a “send offer to the supplier” option, the system 10 then automatically sends the offer form 25 through the data network (internet) to the supplier who decides whether to accept the prospective buyer's offer in step S14. The buyer or system 10 may set a time limit in which the offer may be accepted and the system 10 may itself generate a reminder to the supplier if no response to the offer has been made within a set time limit.

The supplier may choose to accept the offer (step S15) and then decides (step S16) whether to reject the prospective buyer offer (step S17) or counter-offer (step S18).

Reasons for supplier rejection of an offer, and refusal to counter-offer, in step S16 could include insufficient quantity of wine in the prospective buyer offer (noting that the system 10 is aimed primarily at use by wholesale buyers and suppliers); unacceptably low offer price; unavailability of wine or other discretionary reason. The reason does not require to be specified. System 10 then sends an offer rejection notice over the data network (for example by e-mail or SMS) to the prospective buyer. System 10 also displays the rejection notice when the prospective buyer accesses its website.

More usually, the supplier will counter-offer and a bargaining process will be undertaken (at steps S18 and onward) under control of bargaining module 18. To that end, system 10 enables prospective buyer and supplier to bargain a purchase price for a quantity of the wine following buyer sampling. A module 18, as described above, is included in the system 10 for this purpose.

If the supplier chooses to counter-offer, and selects this option, the supplier fills in a counter-offer form online at step S18. This counter-offer form 27 is shown in FIG. 4 and is almost identical to the offer form 25 described above. However, the form is marked “Offer Status: Supplier Counter Offer” to distinguish the form from the initial offer form 25.

Here, the supplier has counter-offered filling the counter-offer form 27 with a price of $3.00 per litre of wine to be purchased. The supplier has chosen not to amend other terms such as those relating to payment terms and requirement for wine filtration. The counter-offer form 27 may be completed over a period of time, the supplier being able to save draft counter-offer and amend this if required. When complete, and the supplier selects the “send offer to the buyer” option, system 10 sends the counter-offer form 27, through a data network (internet) to the prospective buyer for consideration at step S19.

As with an offer, the supplier or system 10 may set a time limit in which the offer may be accepted and the system 10 may itself generate a reminder to the buyer if no response to the offer has been made within a set time limit.

The buyer may consider the offer unacceptable (for example because the unit price of $3.00 per liter is too high) and reject the counter-offer either summarily at step S20 or following a decision not to counter-offer at step S21. In either case, system 10 sends a counter-offer rejection notice to the supplier. System 10 archives details of a rejected sample offer or counter offer. System 10 may recover these details if prospective buyer or seller reconsiders their position.

The buyer may counter-offer at step S22. To do this, a counter-offer form, near identical in format to counter-offer form 27, is completed on-line and sent to the supplier. Though not shown here, such a counter-offer could be based on a further price, say $2.75 per liter.

System 10 allows the supplier to consider the buyer counter-offer and counter-offer at steps S23 and S24 or reject the counter-offer at step S25. Steps S23 and S24 follow the same process as described for steps S17 to S19 above.

A counter-offer process may go through a number of iterations of prospective buyer and supplier counter-offer, the number ideally being capped by system 10. System 10 here provides for ten counter-offers before the bargaining process is terminated and archived.

If an offer/counter-offer is acceptable (step S15), and the bargaining process successfully concludes, system 10, through contracting module 19, generates or raises a contract note documenting the purchase of the sampled wine for the agreed purchase price in step S15. FIG. 5 shows an example contract note 30 which contains the following information:

Offer date

Product description, here 2011 cabernet sauvignon from Western Australia.

Offer price per unit of wine to be supplied and accepted by the supplier.

Tax exempt status

Standard conditions

Buyer and supplier name and address details.

The contract note 30 allows for either buyer or supplier to withdraw from the contract within a specified period from the contract note date. Here, this period is two days but a different “coding off” period could be set.

The contract note 30 also includes a standard condition that the exact composition of the wine will be submitted to the buyer by the supplier in the form of a statement. This statement may include information about the origin and composition of the wine to be supplied as specified by regulation. In Australia, the statement is called a LIP (Label Integrity Program) Statement and evidences that the cabernet sauvignon indeed comes from Western Australia. If there is any discrepancy between the content of the statement and the nature of the wine, the buyer may rescind the contract. System 10 sends the contract note to buyer and seller through the data network. A hard copy may also be sent to registered addresses of buyer and supplier.

The contract is completed when the purchased wine is accepted by the buyer. The supplier may deliver the wine directly to the buyer. More typically, however, the accepted wine is picked up by the buyer. The provider of system 10 does not need to hold, or arrange for holding, the wine in warehouse. This saves warehousing costs and may reduce the time to delivery of the purchased wine.

System 10 allows payment using conventional methods for collection of payments for internet based transactions. The provider of system 10 collects, as remuneration, a proportion of wine purchase price as agreed between the supplier and buyer. To that end, system 10 records contract price as agreed between supplier and buyer and assesses remuneration as a percentage, of the contracted purchase price. The proportion varies with the quantity of wine sold, typically reducing as quantity of beverage purchased increases. The provider of system 10 is independent of wine suppliers and buyers using the system 10.

Further to this, system 10 may record and analyze price and volume information from contracts agreed between suppliers and buyers. In this case, system 10 tracks volumes and prices of wines sold by characteristics such as variety, region of origin, year wine made and so on. System 10 can then provide information about volumes, calculating volumes and average prices and displaying the information on a graph or a bar chart. System 10 may therefore be usefully used as a wine valuation tool, allowing suppliers and buyers to review current prices and design bargaining strategy around those prices. The provider of system 10 may also use the valuation tool to forecast future earnings through provision of the system 10. For example, over time, system 10 records income from wine sales and this information acts as a predictor of future incomes.

While operation of system 10 has been described on the basis of a single wine being the subject of a transaction, a prospective buyer could select a number of wines for sampling and initiate a number of transactions with a supplier. This is a further advantage of the system 10. The wine marketing system not only accelerates the sample to purchase process but it enables a number of wines to be received by the buyer for tasting on or dose to the same day. This is important as buyers wish to evaluate product in one “tasting”. When all samples are in the same spot at the same time a Buyer is able to compare one product against another and this results in a confidence of getting the best product from those available. In addition, system 10 standardization of sample labels enables the buyer to see all information on the wine that he needs to see to make a purchase decision.

System 10 standardization of sample labels significantly reduces the labeling error rate encountered using commonly prior wine acquisition methods. As labeling errors are potentially very costly, due to risk of wasted expenditure (which may involve costs in buying a possibly large volume of wine based on the sample, correcting mislabeling of this volume of wine and defending any legal action arising from labeling errors)|there is significant economic benefit in automating the labeling process and reducing or eliminating labeling errors. System 10 allows this objective to be achieved.

System 10 provides buyers and sellers with readily viewable information about wines under offer, wines for which sample requests have been made and wines for which contracts have been completed. Pages containing this information may be readily uploaded to buyer and seller computers, for viewing, as required.

System 10 includes a tender module 40 allowing buyers to set up a tender for a quantity of wine by selection of a “Tender” option, conveniently displayed in the home page of the system 10 website (as, for example, shown in FIG. 9).

Operation of tender module 40 is described with reference to FIGS. 6 to 10 and, in particular, the block diagram shown in FIG. 6, which block diagram is an alternative to portion of the block diagram shown in FIGS. 2.1 and 2.2. Steps T1 to T3 of the block diagram are identical to steps S1 to S3 described above. In the case of a tender, the buyer sets up a tender at step T4.

Tender module 40 allows a buyer, on selection of a “Create Tender” option on system 10 website, to specify terms for the tender that may cover 1) varieties of grape from which the wine they wish to buy is made, 2) the year the grapes were grown to make the wine, 3) the region from which the grapes were grown (“GI”), 4) the taste of the wine and 5) the price that they are willing to pay for a quantity, typically measured in litres, of the wine.

At step T4, the buyer is presented by system 10 with a new editable tender form 65 (FIG. 7) which requires buyer inputs on:
Product type (Bulk Wine or Cleanskin wine, as selected using drop down box);
Vintage;
Variety;
Region from which wine sought (“GI”, which could be selected using drop down box);
Quantity and Units (as selected using drop down box);
Target Price;
Closing Date; and
Comments (about taste/characteristics of wine sought).

The buyer seeks 5000 litres of a WA gewurtztraminer wine, with fruit driven character, from 2009 or 2010 vintage at target price of $3.00. The illustrative closing date is 30 Mar. 2012. Form 65 is populated with this data with the populated tender form 65A being shown in FIG. 8. If the buyer makes any mistake in populating the form, system 10 allows editing of the tender form to correct the mistake.

At step T5, the buyer selects the “Submit Tender” following which the tender is allocated a serial number (T000015) by system 10 and displayed on the current tenders page of the system 10 website. This current tenders page, including the new tender, is shown in FIG. 9.

A supplier which judges that their wine meets the criteria of the tender may then attach details of their available wine to the T000015 tender within the system 10 at step T6. Here, the supplier has a lower quantity of wine (4000 liters) and seeks a higher price ($3.50 per liter) than the buyer wishes to pay. This would open the way to a negotiation process which the system 10 supervises as described above. The supplier uploads a spreadsheet (or completes a form) with details of suitable wine, the “Current Wine Listing”, and is presented with an option to “Add Selected Wine to Tender” which, on selection, will be recorded as a “Tender Submission”. If the supplier has previously made a tender submission, system 10 allows the supplier to delete the submission through selecting the “Deleted Selected Submissions” option presented as a button. Competing suppliers would not be allowed a delete submission option.

The buyer's tender has a 30 Mar. 2012 deadline. Once the deadline doses (i.e the tender expires), the suppliers who have attached wine to the tender will be sent an automated request to supply samples to the buyer. This allows the buyer to conduct an efficient sampling process.

The sample request notice will be delivered electronically and contain; buyer name, buyer delivery address and electronic links to allow the supplier to access labels which will enable labeling of the product to replicate the codes and details of a particular wine as originally uploaded to the system 10. At this point, the supplier can ascertain who the buyer is and will then be able to accept or reject the sample request based upon their circumstance and their relationship with the potential buyer. The buyer will, following the expiry of the tender deadline and the receipt and tasting of samples, then be in a position to make offers on that wine or wines that are suitable for their purposes. From this step onward, the block diagram is essentially the same as shown in FIGS. 2.1 and 2.2 and described above.

The tender module 40 achieves some important advantages. Firstly, the buyer provides specific detail to the market about wine they wish to acquire. The buyer does not have to make a time consuming search of the market for a wine that suits their purposes and which, very likely, is scarce. This is a major convenience. Suppliers are offered a clear opportunity to sell their product. Typically, a tender would be used to draw bulk and cleanskin wine out of the market (details of such wine not uploaded to information storage device 14 of system 10) but which the suppliers would still sell if an acceptable offer was made. The tender option is ideal for scarce wines where time may be needed to identify available supplies of wine. For wines that are more readily available, the buy option as based on supplier winelists uploaded to the information storage device 14 of system 10 is typically preferable.

Modifications and variations to the above described electronic system for marketing beverages may be apparent to the skilled reader of this disclosure. Such modifications and variations are deemed within the scope of the present invention.

1. An electronic system for marketing beverages comprising:
an information storage device for electronically storing product information about beverages for sale by beverage suppliers;
a module for a prospective buyer to view said beverage product information stored in said information storage device over a data network; and
a module for registering a prospective buyer request of a beverage supplier for a sample of a beverage recorded in the information storage device and sending the sample request to the beverage supplier over a data network;
wherein said electronic system comprises a bargaining module enabling the prospective buyer and a beverage supplier to bargain, through communications sent through the data network, a purchase price for a quantity of the beverage following buyer sampling; and a contracting module enabling the beverage supplier to contract with the buyer for purchase of a quantity of sampled beverage at an agreed purchase price, the bargaining and contracting steps being conducted over the data network.

2. The electronic system of claim 1 being applied to marketing of commercial quantities of the beverage, said prospective buyer being a wholesale purchaser of the beverage.

3. The electronic system of claim 1 wherein beverage suppliers and prospective buyers are required to register to use the system.

4. The electronic system of claim 3 wherein a supplier is permitted to load information about its beverage products into the information storage device of the system following registration.

5. The electronic system of claim 1 wherein samples are sent directly from the beverage supplier to the prospective buyer.

6. The electronic system of claim 1 wherein the supplier has discretion to reject a sample request and, on rejection, a rejection notice is sent, by the system, to the prospective buyer over the data network.

7. The electronic system of claim 1 wherein said bargaining module controls the bargaining process and includes provision for a bargaining process including a number of online offer and counter-offer iterations by prospective buyer and supplier

8. The electronic system of claim 7 wherein the number of online iterations of counter-offer is capped by the system.

9. The electronic system of claim 1 wherein a purchased quantity of beverage is supplied directly from beverage supplier to buyer without the system provider warehousing the purchased quantity of beverage.

10. The electronic system of claim 1 wherein a provider of the system collects a proportion of said agreed beverage purchase price.

11. The electronic system of claim 1 which records and analyses information from contracts agreed between suppliers and buyers for use as a beverage valuation tool.

12. The electronic system of claim 1 including a tender module which allows a beverage supplier to create and record a tender for supply of at least one beverage product to it.

13. A method for marketing beverages over a data network communicating beverage buyers and beverage suppliers through an electronic system which comprises an information storage device for electronically storing product information about beverages available for supply to buyers by beverage suppliers and further comprising:
providing a prospective buyer with access to said beverage product information over the data network;
registering and sending a prospective buyer request for a sample of an available beverage recorded in the information storage device to a supplier over the data network;
bargaining between prospective buyer and supplier, through communications sent through the data network, a purchase price for a quantity of the beverage; and
contracting between buyer and supplier for purchase of a quantity of the beverage a agreed purchase price.

14. The method of claim 13 being applied to marketing of commercial quantities of the beverage, said prospective buyer being a wholesale purchaser of the beverage.

15. The method of claim 13 wherein beverage suppliers and prospective buyers are required to register to use the system.

16. The method of claim 15 wherein a supplier is permitted to load information about its beverage products into the information storage device of the system following registration.

17. The method of claim 13 wherein samples are sent directly from the beverage supplier to the prospective buyer.

18. The method of claim 13 wherein a purchased quantity of beverage is supplied directly from beverage supplier to buyer without the system provider warehousing the purchased quantity of beverage.

19. The method of claim 13 wherein said electronic system records and analyses information from contracts agreed between suppliers and buyers for use as a beverage valuation tool.

20. The method of claim 13 wherein said electronic system allows a beverage supplier to create and record a tender for supply of at least one beverage product to it.
